(19) United States
(12) Patent Application Publication
(10) Pub. No.: US 2014/0071003 A1
(43) Pub. Date: Mar. 13, 2014

(54) Replacement Antenna for Vehicle

(71) Applicant: Beat-Sonic Co., Ltd., Nisshin-shi (JP)

(72) Inventor: Tsutomu Totani, Nisshin-shi (JP)

(73) Assignee: Beat-Sonic Co., Ltd., Nisshin-shi (JP)

(21) Appl. No.: 13/974,279

(22) Filed: Aug. 23, 2013

(30) Foreign Application Priority Data
Sep. 11, 2012 (JP) 2012-199163

(51) Int. Cl. H01Q 1/32

(52) U.S. Cl. CPC H01Q 1/3275
USPC 343/713

(57) ABSTRACT

A replacement antenna for a vehicle is mounted as replacement for a pole antenna mounted in a screw hole of a boss mounted on a vehicle roof panel. The replacement antenna includes an attachment formed with a boss opening in which a boss is fitted and a casing having an appearance such that a front is tapered toward a bottom, the casing having an antenna wire built-in and having an attachment opening formed in the bottom so that the attachment is fitted in the attachment opening. The casing has a double-faced adhesive tape affixed on it. The boss is fitted in the boss opening so that the attachment is positioned relative to the boss and fixed to the roof panel. The attachment fixed to the roof panel is fitted in the attachment opening and the casing is fixed to the roof panel by the adhesive tape.

### CROSS-REFERENCE TO RELATED APPLICATIONS

This application is based upon and claims the benefit of priority from the prior Japanese Patent Application No. 2012-199163 filed on Sep. 11, 2012, the entire contents of which are incorporated herein by reference.

### BACKGROUND

1. Technical Field

The present disclosure relates to a replacement antenna for vehicle and more particularly to such a replacement antenna for vehicle, which is used to replace a pole antenna installed on a roof panel of a vehicle.

2. Related Art

A pole antenna would be broken or bent when a vehicle is washed by a car washing machine with the pole antenna being kept standing or when the vehicle enters a multistory parking lot. Accordingly, the pole antenna needs to be detached from the roof panel before the vehicle enters the multistory parking lot and the car washing machine, and the pole antenna needs to be re-attached to the roof panel after the vehicle exits the multistory parking lot and the car washing machine. The pole antenna is thus inconvenient.

To eliminate the above-described inconvenience, Japanese Patent Nos. 4413974 and 4798721 disclose respective replacement antennas for vehicle, which can be used to replace an original pole antenna. Each conventional replacement antenna for vehicle includes a casing having a bottom with an opening and formed into a hollow structure. The casing has an appearance such that the casing is tapered toward the roof panel when installed on the roof panel. Each conventional replacement antenna has an antenna wire built-in.

Each conventional replacement antenna is placed on an antenna-standing boss so as to cover the boss . A peripheral edge of the bottom opening is caused to adhere to the roof panel by a double-faced adhesive tape thereby to be fixed.

The casing of each replacement antenna has a tapered appearance. Accordingly, when attached to the roof panel of the vehicle, each replacement antenna can be prevented from being broken or bent even in the case where the vehicle is washed by a car washing machine or the vehicle enters a multistory parking lot. Furthermore, since each replacement antenna is caused to adhere to the roof panel by the double-faced adhesive tape, no hole needs to be bored in the roof panel of the vehicle for the purpose of fixing each replacement antenna.

In each of the above-described conventional replacement antennas, the casing is caused to cover the boss and to adhere to the roof panel by the double-faced adhesive tape. Accordingly, the casing is displaced from a predetermined position on the roof panel in a front-back direction or is tilted in a front-back direction during adhesion. This would degrade a visual quality of the roof panel to which the casing is fixed.

### SUMMARY

Therefore, an object of the disclosure is to provide a replacement antenna for vehicle, which can be mounted on the roof panel without degrading the appearance of the roof panel of the vehicle and without machining such as boring in the roof panel.

The present disclosure provides a replacement antenna for a vehicle, which is mounted as replacement for a pole antenna detachably mounted in a screw hole of a boss provided on a roof panel of a vehicle. The replacement antenna comprises an attachment formed with a boss opening in which a boss is fitted and a casing having an appearance such that a front thereof is tapered toward a bottom thereof. The casing has an antenna wire built-in and having an attachment opening formed in the bottom thereof so that the attachment is fitted in the attachment opening. The casing has a double-faced adhesive tape affixed thereto. In the replacement antenna, the boss is fitted in the boss opening of the attachment so that the attachment is positioned relative to the boss and fixed to the roof panel. The antenna wire is connected to the screw hole of the boss. The attachment fixed to the roof panel is fitted in the attachment opening of the casing and the casing is fixed to the roof panel by the double-faced adhesive tape.

In the above-described construction, the boss is fitted in the boss opening of the attachment so that the attachment is positioned relative to the boss and fixed to the roof panel. The attachment fixed to the roof panel is fitted in the attachment opening of the casing, and the casing is fixed to the roof panel by the double-faced adhesive tape. Accordingly, the casing can be positioned relative to the boss. This can prevent the casing from being displaced from a predetermined position on the roof panel in a front-back direction or from being tilted in a front-back direction during adhesion. Consequently, the casing can be mounted on the roof panel highly attractively.

In an embodiment, the attachment has a bottom to which another double-faced adhesive tape is affixed and is fixed to the roof panel by said another double-faced adhesive tape.

In another embodiment, the attachment has a screw hole for a setscrew reaching the boss opening, and the setscrew has a distal end which is pressed against the boss when the setscrew is tightened into the screw hole, whereby the attachment is fixed to the boss.

In further another embodiment, the casing has a through hole, the attachment has a screw hole, and a screw is tightened through the through hole of the casing into the screw hole of the attachment, whereby the casing is fixed to the attachment.

In further another embodiment, the attachment has a front end surface formed into a tapered surface and the attachment opening of the casing has a front end surface formed with an inverse tapered surface into which the tapered surface of the attachment bites.

In further another embodiment, the attachment has a front end provided with an engagement piece which is engageable with an upper front end of the attachment opening of the casing. The attachment has a rear end provided with a lock piece which is bendable in a front-back direction, the lock piece being engageable with an upper rear end of the attachment opening when bent backward, the lock piece being disengageable from the upper rear end of the attachment opening when bent frontward. The casing has a rear end formed with a pin insertion through hole. The upper front end of the attachment opening of the casing engages the engagement piece of the attachment and the lock piece of the attachment engages the upper rear end of the attachment opening, whereby the casing is fixed to the attachment. A pin is inserted through the pin insertion through hole and the lock piece is bent frontward, whereby the lock piece disengages from the upper rear end of the attachment opening.

### BRIEF DESCRIPTION OF THE DRAWINGS

In the accompanying drawings:

FIG. 1 is an exploded perspective view of a replacement antenna for vehicle according to a first embodiment;

FIG. 2 is a longitudinal section of the replacement antenna according to the first embodiment;

FIG. 3 illustrates a pole antenna mounted on a boss provided on a roof panel of vehicle;

FIG. 4 is an exploded perspective view of the replacement antenna for vehicle according to a second embodiment;

FIG. 5 is a longitudinal section of the replacement antenna according to the second embodiment;

FIG. 6 is an exploded perspective view of the replacement antenna for vehicle according to a third embodiment;

FIG. 7 is a longitudinal section of the replacement antenna according to the third embodiment; and

FIG. 8 is another longitudinal section of the replacement antenna according to the third embodiment.

### DETAILED DESCRIPTION

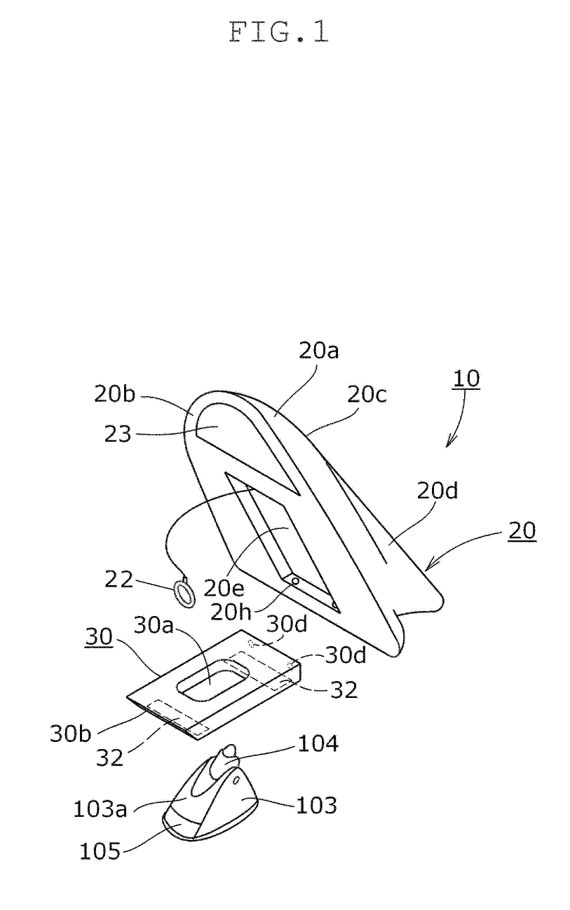

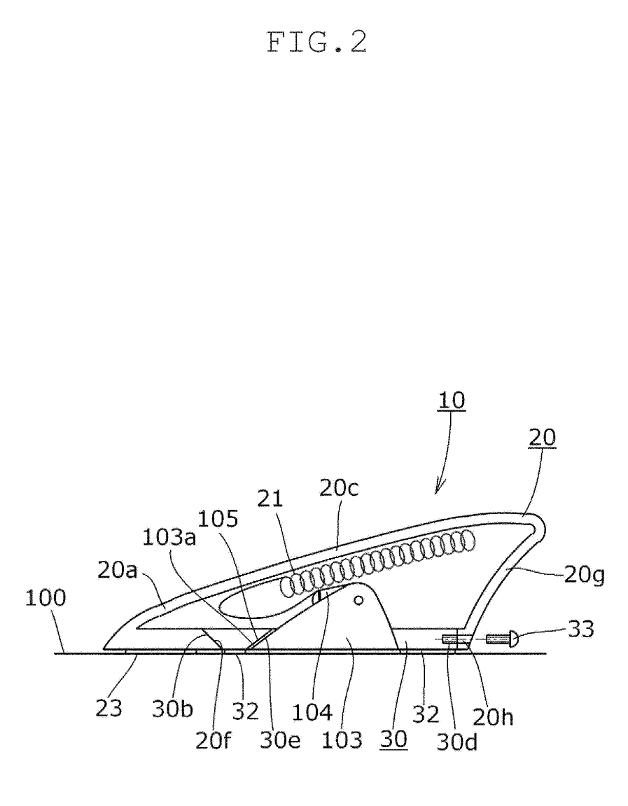

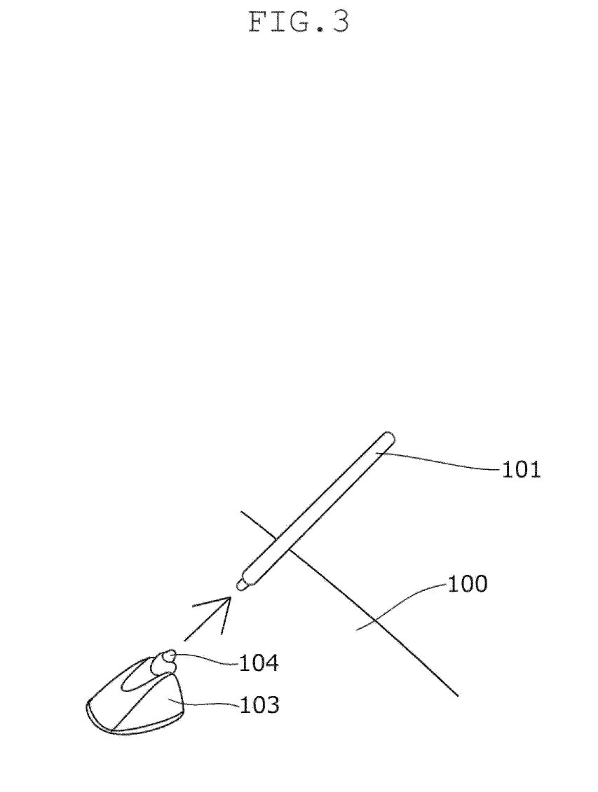

Several embodiments will be described with reference to the accompanying drawings. Referring to FIGS. 1 and 2, the replacement antenna 10 for a vehicle according to a first embodiment is shown. The replacement antenna 10 is mounted on a roof panel 100 of a vehicle, instead of a pole antenna 101 mounted on the roof panel 100, as shown in FIG. 3. The pole antenna 101 is detachably attached to a boss 103 mounted on the roof panel 100. The boss 103 has an appearance of a circular truncated cone and has a top to which a cylindrical shaft 104 made of a metal is mounted so as to be rotatable in a front-back direction. The cylindrical shaft 104 has a distal end formed with a screw hole. The pole antenna 101 is detachably attached into the screw hole. The screw hole is connected via wiring (not shown) to audio equipment in a vehicle compartment.

The replacement antenna 10 includes a casing 20 and an attachment 30. The casing 20 is a plastic molding and has a hollow structure. The casing 20 includes a front 20a tapered toward a bottom 20b and a fin 20d which is formed on a top 20c so as to extend from a middle part toward a rear end. The bottom 20b of the casing 20 is formed with a rectangular attachment opening 20e which is formed so as to have a predetermined shape and predetermined dimensions so that the attachment 30 is fitted in the opening 20e, as will be described later. A coil antenna 21 is provided inside the top 20c. A lug terminal 22 is connected to the coil antenna 21. The attachment opening 20e has a front end formed into a tapered surface 20f which is inclined backwardly downward as shown in FIG. 2. The casing 20 has a rear end 20g including a lower part formed with smaller screw through hole 20h. A double-faced adhesive tape 23 is affixed to a part of the casing 20 located in front of the attachment opening 20e.

The attachment 30 has a rectangular profile so as to be fitted in the attachment opening 20e of the casing 20. The attachment 30 has a centrally formed rectangular boss opening 30a in which the boss 103 is fittable. The boss opening 30a includes a front end 30e, a rear end and right and left sides all forming a curved surface which is adapted to be brought into close contact with a curved surface formed by a lower front, a lower rear and lower right and left sides of the boss 103 respectively when the attachment 30 is placed on the boss 103. The attachment 30 has a front end formed into an inverse tapered surface 30b which can bite into the tapered surface 20f of the front end of the attachment opening 20e. The attachment 30 has a rear end formed with a screw hole 30d for a smaller screw. A double-faced adhesive tape 105 is affixed to a curved surface 103a on the lower front of the boss 103 with which the front end 30e of the boss opening 30a is brought into close contact when the attachment 30 is placed on the boss 103. Furthermore, double-faced adhesive tapes 32 are affixed to front and rear ends of the bottom of the attachment 30 respectively.

The casing 20 and the attachment 30 are structured as described above. Cover sheets are removed from the double-faced adhesive tape 105 of the boss 103 and the double-faced adhesive tapes 32 of the attachment 30 respectively. The attachment 30 is placed on the boss 103 so that the boss 103 is fitted into the boss opening 30a of the attachment 30 and so that the boss 103 extends through the boss opening 30a of the attachment 30. As a result, since the attachment 30 is positioned relative to the boss 103, the attachment 30 is fixed to the roof panel 100 by the double-faced adhesive tapes 32, and the double-faced adhesive tape 105 is affixed to the front end 30e of the attachment 30, whereby the attachment 30 is fixed to the boss 103.

The lug terminal 22 of the coil antenna 21 is connected to the screw hole of the cylindrical shaft 104. A cover sheet of the double-faced adhesive tape 23 of the casing 20 is removed, and the attachment opening 20e of the casing 20 is fitted with the attachment 30. At this time, the inverse tapered surface 20f of the front end of the attachment opening 20e is firstly caused to bite into the tapered surface 30b of the front end of the attachment 30, and thereafter, the rear end of the attachment 30 is fitted with the rear end of the attachment opening 20e. Subsequently, the smaller screws 32 are inserted through the respective smaller screw holes 20h and further screwed into the respective screw holes 30d, so that the casing 20 is fixed to the attachment 30 by the smaller screws 32. The bottom front of the casing 20 is caused to adhere to the roof panel 100 by the double-faced adhesive tape 23.

According to the first embodiment, the attachment 30 is positioned relative to the boss 103 when the boss 103 is fitted in the boss opening 30a of the attachment 30. The attachment 30 thus positioned is fitted in the attachment opening 20e of the casing 20, and the casing 20 is fixed to the roof panel 100. Accordingly, the casing 20 can be positioned relative to the boss 103. This can prevent the casing 20 from being displaced from a predetermined position on the roof panel 100 in a front-back direction or being tilted in a front-back direction. Consequently, the casing 20 can be attached to the roof panel 100 with good appearance.

Furthermore, the casing 20 is fixed by the smaller screws 32 to the attachment 30 fixed to the roof panel 100 and the boss 103 by the respective double-faced adhesive tapes 32 and 105. Thus, the casing 20 can firmly be fixed to the roof panel 100.

The casing 20 is fixed to the attachment 30 by the smaller screws 32 after the inverse tapered surface 20f of the casing 20 has been caused to bite into the tapered surface 30b of the front end of the attachment 30 fixed to the boss 103. This can render the fixing work easier.

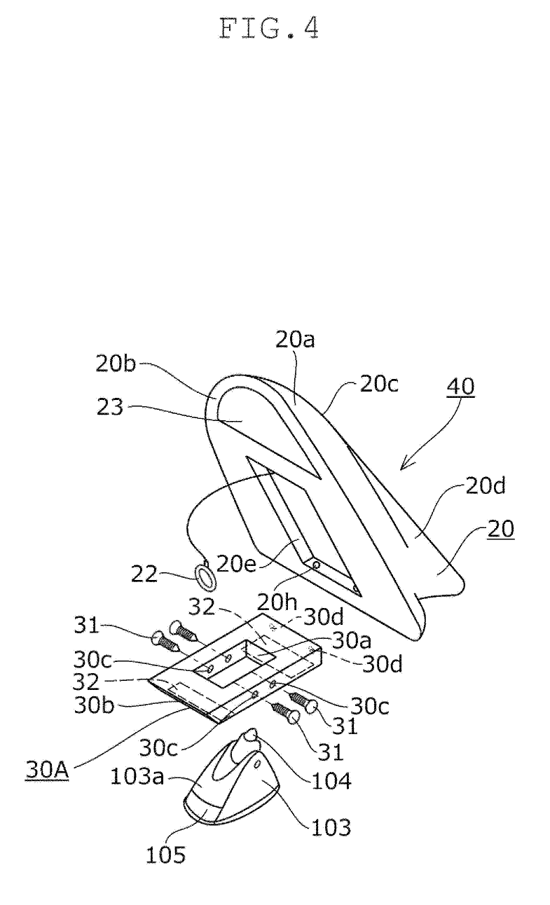

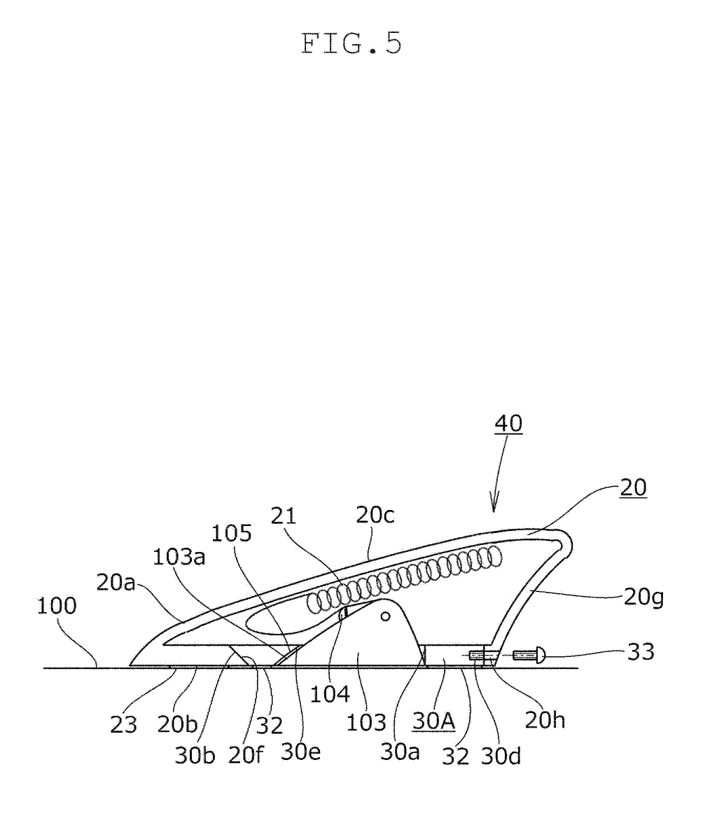

FIGS. 4 and 5 illustrate a second embodiment. In the first embodiment, in order that the boss 103 may closely be fitted in the boss opening 30a of the attachment 30 when the attachment 30 is placed on the boss 103, the front end 30e, the rear end and the right and left sides of the attachment 30 are formed into the curved surface which is adapted to be brought into close contact with the curved surface formed by the lower front, the lower rear and lower right and left sides of the boss 103 respectively. On the other hand, in the second embodiment, the boss opening 30a of the attachment 30A has the front end surface 30e formed into a curved surface matched with a curved surface of the lower front 103a of the boss 103. However, the boss opening 30a has a rear end and right and left sides all of which are formed into vertical surfaces. Accordingly, a slight clearance is defined between the boss 103 and the boss opening 30a of the attachment 30A when the attachment 30A is placed on the boss 103.

The right and left sides of the attachment 30A are formed with respective setscrew holes 30c into which setscrews 31 are screwable. Each setscrew hole 30c has such a length as to reach the boss opening 30a. The structure of the vehicle replacement antenna according to the second embodiment is identical with that in the first embodiment in the other respects than described above. Accordingly, identical or similar parts in the second embodiment are labeled by the same reference symbols as those in the first embodiment and description of these parts will be eliminated.

The casing 20 and the attachment 30 of the vehicle replacement antenna 40 according to the second embodiment are structure as described above. Cover sheets are removed from the double-faced adhesive tape 105 of the boss 103 and the double-faced adhesive tapes 32 of the attachment 30A respectively. The attachment 30A is placed on the boss 103 so that the boss 103 is fitted into the boss opening 30a of the attachment 30A, and the attachment 30A is fixed to the roof panel 100 by the double-faced adhesive tapes 32. The setscrews 31 are screwed into setscrew holes 30c so that distal ends of the setscrews 31 are pressed against the boss 103, whereby the attachment 30A is fixed to the boss 103. Furthermore, the attachment 30A is fixed to the boss 103 by the double-faced adhesive tape 105. The position and orientation of the attachment 30A are adjusted when the attachment 30A is fixed to the roof panel 100 by the double-faced adhesive tapes 32.

In the above-described vehicle replacement antenna 40 according to the second embodiment, when the boss 103 is fitted in the boss opening 30a of the attachment 30A, the attachment 30A is fixed to the roof panel 100 while the position and orientation of the attachment 30A are adjusted. The casing 20 is fitted with the attachment 30A thus fixed to the roof panel 100. This can prevent the casing 20 from being displaced from a predetermined position on the roof panel 100 in a front-back direction or being tilted in a front-back direction. Consequently, the casing 20 can be attached to the roof panel 100 with good appearance. Furthermore, since the attachment 30A is fixed to the boss 103 by the setscrews 31, the attachment 30A and the casing 20 can firmly be fixed to the roof panel 100.

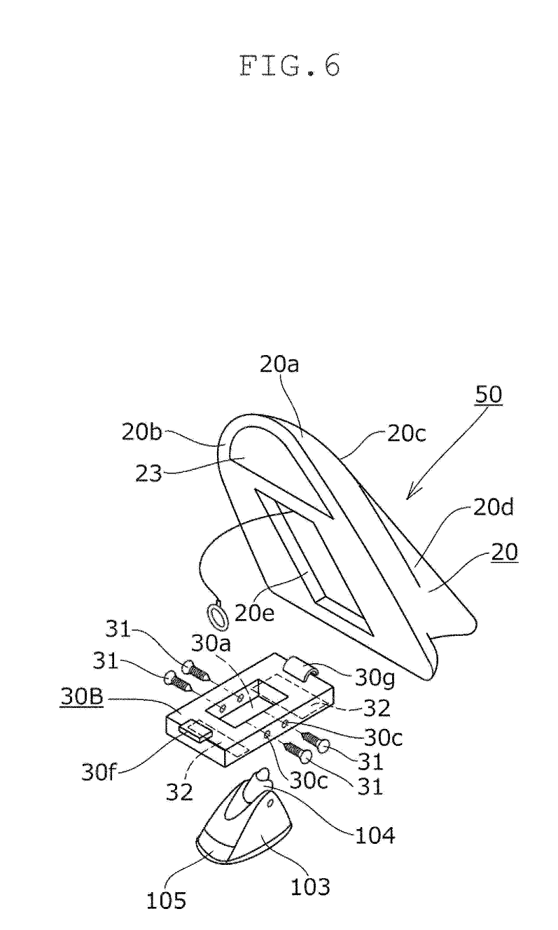

FIGS. 6 to 8 illustrate the vehicle replacement antenna 50 according to a third embodiment. The front end surface of the attachment opening 20e of the casing 20 is formed into the tapered surface 20f in the replacement antenna 10 according to the second embodiment. In the third embodiment, however, the front end surface of the attachment opening 20e of the replacement antenna 50 is formed into a vertical surface. Furthermore, although the smaller screw through hole 20h is formed in the lower part of the rear end 20g of the casing 20 in the second embodiment, the casing 20 in the third embodiment has no smaller screw through hole but is formed with a pin insertion through hole 20k.

The front end of the attachment 30B of the replacement antenna 50 is formed with an engagement piece 30f which is adapted to be engaged with the upper front end of the attachment opening 20e. The rear end of the attachment 30 has an inverted U-shaped section and is provided with a lock piece 30g which is bendable in the front-back direction. When bent rearward, the lock piece 30g is adapted to engage the upper rear end of the attachment opening 20e. When bent frontward, the lock piece 30g is adapted to disengage from the upper rear end of the attachment opening 20e. The construction of casing 20 and the attachment 30 in the third embodiment is identical with that in the second embodiment in the other respects than described above. Accordingly, identical or similar parts in the third embodiment are labeled by the same reference symbols as those in the second embodiment and description of these parts will be eliminated.

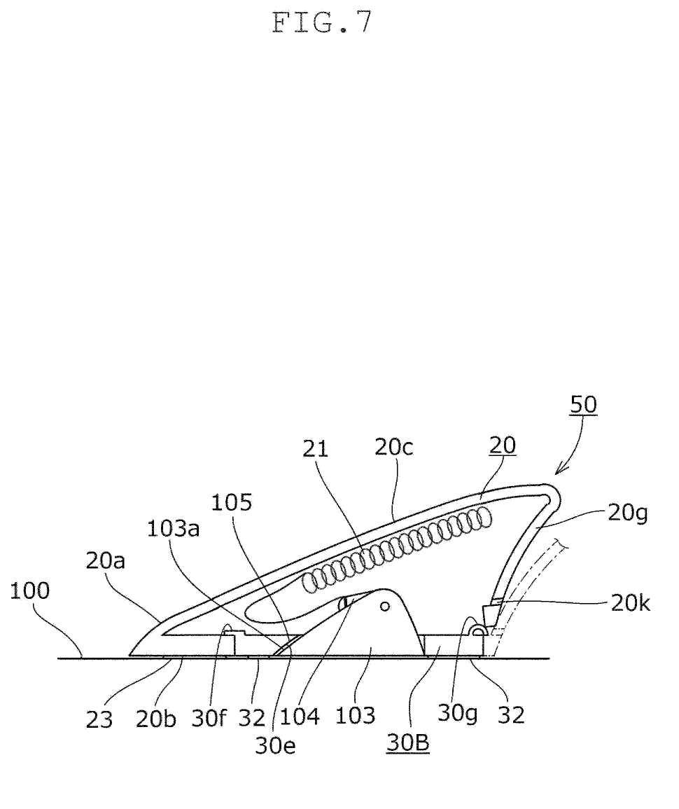

In the mounting of the replacement antenna 50 on the roof panel 100, the attachment 30B is fixed to the roof panel 100 by the double-faced adhesive tapes 32 and to the boss 103 by the setscrews 31 in the same manner as the attachment 30A in the second embodiment. The casing 20 is placed so as to cover the attachment 30B so that the attachment 30B is fitted in the attachment opening 20e of the casing 20 and so that the engagement piece 30f of the attachment 30B engages the upper front end of the attachment opening 20e. Subsequently, the rear end of the attachment opening 20e is caused to cover the rear end of the attachment 30B. As shown in FIG. 7, the rear end of the attachment opening 20e abuts against the distal end of the lock piece 30g thereby to be bent frontward. When the lock piece 30g is bent frontward and the rear end of the attachment opening 20e passes the distal end of the lock piece 30g, the lock piece 30g is then bent rearward thereby to engage the upper rear end of the attachment opening 20e. Thus, the casing 20 is fixed to the attachment 30B.

In order that the casing 20 may be detached from the attachment 30B, a pin 41 is inserted through the pin insertion through hole 20k so that the lock piece 30g is bent frontward, whereby the lock piece 30g disengages from the upper rear end of the attachment opening 20e.

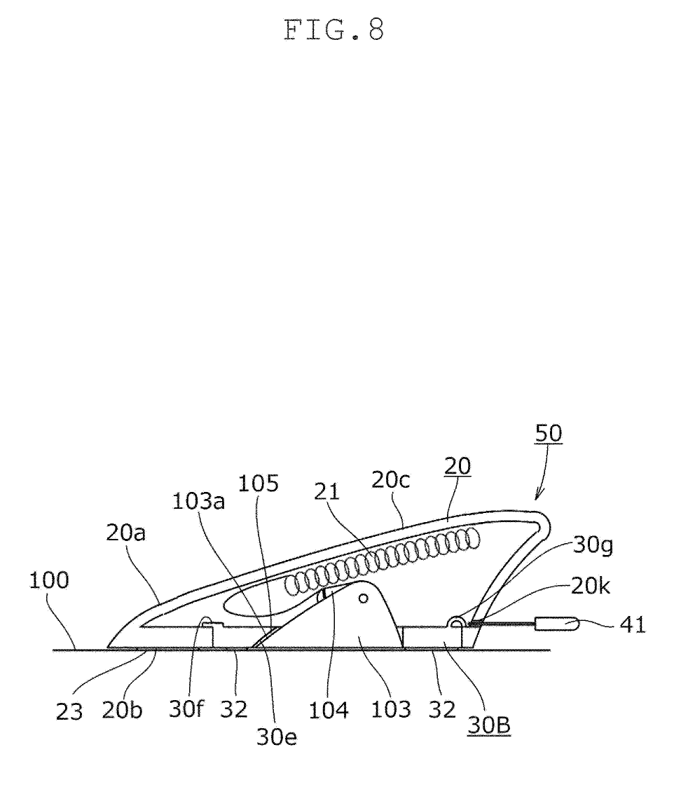

According to the replacement antenna 50, the engagement piece 30f of the attachment 30B fixed to the boss 103 engages the upper front end of the attachment opening 20e, and the lock piece 30g of the attachment 30B engages the upper rear end of the attachment opening 20e, as shown in FIG. 8. As a result, the casing 20 can be fixed to the attachment 30B. Furthermore, when the pin 41 is inserted through the pin insertion through hole 20k so that the lock piece 30g is bent frontward, the lock piece 30g disengages from the upper rear end of the attachment opening 20e, whereby the casing 20 can be detached from the attachment 30. Consequently, the casing 20 can easily be attached to and detached from the attachment 30B.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A replacement antenna for a vehicle, which is mounted as replacement for a pole antenna detachably mounted in a screw hole of a boss provided on a roof panel of a vehicle, the replacement antenna comprising:
an attachment formed with a boss opening in which a boss is fitted; and
a casing having an appearance such that a front thereof is tapered toward a bottom thereof, the casing having an antenna wire built-in and having an attachment opening formed in the bottom thereof so that the attachment is fitted in the attachment opening, the casing having a double-faced adhesive tape affixed thereto,
wherein the boss is fitted in the boss opening of the attachment so that the attachment is positioned relative to the boss and fixed to the roof panel;
the antenna wire is connected to the screw hole of the boss; and
the attachment fixed to the roof panel is fitted in the attachment opening of the casing and the casing is fixed to the roof panel by the double-faced adhesive tape.

2. The replacement antenna according to claim 1, wherein the attachment has a bottom to which another double-faced adhesive tape is affixed and is fixed to the roof panel by said another double-faced adhesive tape.

3. The replacement antenna according to claim 1, wherein the attachment has a screw hole for a setscrew reaching the boss opening, and the setscrew has a distal end which is pressed against the boss when the setscrew is tightened into the screw hole, whereby the attachment is fixed to the boss.

4. The replacement antenna according to claim 1, wherein the casing has a through hole, the attachment has a screw hole, and a screw is tightened through the through hole of the casing into the screw hole of the attachment, whereby the casing is fixed to the attachment.

5. The replacement antenna according to claim 1, wherein the attachment has a front end surface formed into a tapered surface and the attachment opening of the casing has a front end surface formed with an inverse tapered surface into which the tapered surface of the attachment bites.

6. The replacement antenna according to claim 1, wherein:
the attachment has a front end provided with an engagement piece which is engageable with an upper front end of the attachment opening of the casing;
the attachment has a rear end provided with a lock piece which is bendable in a front-back direction, the lock piece being engageable with an upper rear end of the attachment opening when bent backward, the lock piece being disengageable from the upper rear end of the attachment opening when bent frontward;
the casing has a rear end formed with a pin insertion through hole;
the upper front end of the attachment opening of the casing engages the engagement piece of the attachment and the lock piece of the attachment engages the upper rear end of the attachment opening, whereby the casing is fixed to the attachment; and
a pin is inserted through the pin insertion through hole and the lock piece is bent frontward, whereby the lock piece disengages from the upper rear end of the attachment opening.
